(19) United States
(12) Patent Application Publication
(10) Pub. No.: US 2025/0003931 A1
(43) Pub. Date: Jan. 2, 2025

(54) METHOD OF PRESUMING STRUCTURE OF TARGET COMPOUND CONTAINING ACYL GROUP

(71) Applicant: Shimadzu Corporation, Kyoto (JP)

(72) Inventors: Kosuke NAKAJIMA, Singapore (SG); Hidetoshi TERADA, Kyoto (JP)

(73) Assignee: Shimadzu Corporation, Kyoto (JP)

(21) Appl. No.: 18/754,188

(22) Filed: Jun. 26, 2024

(30) Foreign Application Priority Data
Jun. 30, 2023 (SG) 10202301874U

(51) Int. Cl. G01N 30/86; G01N 30/72

(52) U.S. Cl. CPC G01N 30/8679; G01N 30/7233

(57) ABSTRACT

A method of estimating a structure of a target compound containing a linear acyl group, the method comprising:
analyzing a sample containing the target compound on a chromatograph to determine a retention time; and
estimating a combination of a total number of carbon atoms and a total number of carbon-carbon double bond(s) in the acyl group in the target compound from the retention time, based on the following equations 1 and 2:

N=f(T) (Equation 1)

T=t/D^{m} (Equation 2).

### CROSS REFERENCE TO RELATED APPLICATIONS

This nonprovisional application is based on Singapore Patent Application No. 10202301874U filed on Jun. 30, 2023, with the Intellectual Property Office of Singapore, the entire contents of which are hereby incorporated by reference.

### BACKGROUND OF THE INVENTION

### Field of the Invention

The present disclosure relates to a method of estimating a structure of a target compound containing an acyl group.

### Description of the Background Art

Triacylglycerol (TAG) is a compound that is composed of three fatty acid molecules bonded to one glycerol molecule via ester bonds, and it is a type of neutral fat which belongs to the category of simple lipids. TAG is the major component of edible oils/fats, and contained in vegetable oil, butter, margarine, cow milk, beef, pork, chicken, soy, nuts, and so on. The composition of TAG varies depending on the origin. To take plant-derived oils as examples, olive oil has a high content of oleic acid (C18:1, 18 carbon atoms, 1 double bond) in terms of TAG-constituting fatty acid, and soybean oil has a high content of linoleic acid (C18:2, 18 carbon atoms, 2 double bonds). Cocoa butter, which is an ingredient of chocolate, is predominantly composed of palmitic acid (C16:0, 16 carbon atoms, 0 double bond), stearic acid (C18:0, 18 carbon atoms, 0 double bond) (both belong to the category of saturated fatty acids), and oleic acid, in terms of TAG-constituting fatty acid. In other words, analyzing the type and ratio of fatty acids (acyl groups) that constitute TAG makes it possible to estimate the type of oil/fat, so there is a need for a method for identifying fatty acids that constitute TAG.

For example, Patent Literature 1 (Japanese Patent No. 7019281) discloses a method for analyzing the triacylglycerol composition of a composition that contains two or more different triacylglycerols in which the total number of fatty acid residues (the total number of carbon atoms) is the same as one another, wherein the method comprises the following (a) and (b):
(a) separating, by mass spectrometry, each triacylglycerol into corresponding diacylglycerol and fatty acid fragments; and
(b) separating, by mass spectrometry, each diacylglycerol thus detected in step (a) into corresponding fatty acid fragments.

### SUMMARY OF THE INVENTION

However, the method disclosed in Patent Literature 1 takes many man-hours, and, therefore, an easier and simpler analysis method is demanded. Moreover, there are numerous combinations of fatty acids in a TAG (at least 3000 combinations), so it is not an easy task to prepare reference standards for all the possible combinations prior to TAG analysis. For this reason, there is a need for a method capable of estimating TAG-constituting fatty acids without requiring reference standards for possible combinations of fatty acids.

The present invention has been devised in light of the above-described circumstances, and an object thereof is to provide a method for easy and simple estimation for a target compound containing an acyl group, in terms of the total number of carbon atoms in the acyl group as well as the total number of carbon-carbon double bond(s) in the acyl group.

The inventors of the present invention have conducted intensive research, and, as a result, have found that the retention time in chromatograph analysis correlates with the total number of carbon atoms in the acyl group and the total number of carbon-carbon double bond(s) in the acyl group in the target compound. Thus, the present invention has now been completed.

A first aspect of the present invention relates to a method of estimating a structure of a target compound containing a linear acyl group, the method comprising:
analyzing a sample containing the target compound on a chromatograph to determine a retention time; and
estimating a combination of a total number of carbon atoms and a total number of carbon-carbon double bond(s) in the acyl group in the target compound from the retention time, based on the following equations 1 and 2:

N=f(T) (Equation 1)

T=t/D^{m} (Equation 2)
in the equation 1, N represents the total number of carbon atoms in the acyl group, and f(T) represents a function that is derived from a homologue of a saturated compound corresponding to the target compound and that expresses a correlation between the total number of carbon atoms and the retention time; and in the equation 2, t represents the retention time, D represents a coefficient based on carbon-carbon double bond(s), and m represents the total number of carbon-carbon double bond(s).

A second aspect of the present invention relates to a computer-readable storage medium storing a database that is to be used for causing a computer to implement the method of estimating a structure according to the first aspect, wherein
the database stores:
   analysis conditions for the chromatograph; and
   the function f(T) derived at the time of analysis of the homologue under the analysis conditions, and the coefficient D based on carbon-carbon double bond(s),
in association with one another.

According to the present invention, it is possible to provide a method for easy and simple estimation for a target compound containing an acyl group, in terms of the total number of carbon atoms in the acyl group as well as the total number of carbon-carbon double bond(s) in the acyl group.

### BRIEF DESCRIPTION OF THE DRAWINGS

FIG. 1 shows a graph that presents results of analysis of fully saturated triacylglycerols carried out on a supercritical fluid chromatograph (left), and a graph that presents the correlation between the total number of carbon atoms in the acyl groups in the triacylglycerols (on the horizontal axis) and the retention time (on the vertical axis) based on the analysis results (right). On the left graph, the horizontal axis indicates the retention time (minutes), and the vertical axis indicates the detection intensity.

FIG. 2 shows a graph that presents results of analysis of triacylglycerols carried out on a supercritical fluid chromatograph (left), and a table that presents the correlation between the total number of carbon-carbon double bond(s) in the acyl groups in the triacylglycerols and the retention time based on the analysis results (right).

FIG. 3 is a graph that presents results of analysis of a triacylglycerol carried out on a supercritical fluid chromatograph.

### DESCRIPTION OF THE PREFERRED EMBODIMENTS

In the following, a description will be given of an embodiment of the present invention (hereinafter referred to as “the present embodiment”). It should be noted that the present embodiment is not limited to the below description. In the present specification, the expression “from A to Z” means the upper limit and the lower limit of a range (that is, it means not less than A and not more than Z), and if a description of unit is attached only to Z but not to A, A has the same unit as that of Z.

### <<Method of Estimating a Structure of a Target Compound Containing a Linear Acyl Group>>

A first aspect of the present invention relates to a method of estimating a structure of a target compound containing a linear acyl group, the method comprising:
analyzing a sample containing the target compound on a chromatograph to determine a retention time; and
estimating a combination of a total number of carbon atoms and a total number of carbon-carbon double bond(s) in the acyl group in the target compound from the retention time, based on the following equations 1 and 2:

N=f(T) (Equation 1)

T=t/D^{m} (Equation2)
in the equation 1, N represents the total number of carbon atoms in the acyl group, and f(T) represents a function that is derived from a homologue of a saturated compound corresponding to the target compound and that expresses a correlation between the total number of carbon atoms and the retention time; and in the equation 2, t represents the retention time, D represents a coefficient based on carbon-carbon double bond(s), and m represents the total number of carbon-carbon double bond(s).

### <Analyzing a Sample Containing a Target Compound on a Chromatograph to Determine a Retention Time>

In this step, a sample containing a target compound is analyzed on a chromatograph to determine a retention time. The target compound contains a linear acyl group. Herein, the “retention time” means the time from injection of the solute onto the chromatograph column until elution thereof.

### (Target Compound)

In the present embodiment, as for the target compound, any compound that contains at least one linear acyl group may be used as the analysis target compound, without particular limitation. The acyl group may be a linear saturated acyl group, or may be a linear unsaturated acyl group. The number of carbon atoms in one acyl group may be not less than 2 and not more than 30, or not less than 6 and not more than 24. The number of carbon-carbon double bonds in one acyl group may be not less than 0 and not more than 6, or may be not less than 0 and not more than 3. The number of acyl groups in the target compound may be not less than 1 and not more than 3, or may be not less than 1 and not more than 2.

Examples of the target compound include triacylglycerols (which can be expressed as “TAG” hereinafter), diacylglycerols, monoacylglycerols, sterol lipids, glycerophospholipids, and sphingophospholipids. In an aspect of the present embodiment, the target compound is preferably a triacylglycerol.

In the present embodiment, the sample containing the target compound may be either liquid or solid, without particular limitation. From the viewpoint of ease of the chromatograph analysis, the sample is preferably liquid. In an aspect of the present embodiment, the sample may be derived from a living thing, or may be derived from food.

In the present embodiment, the chromatograph may be any known chromatograph, without particular limitation. Examples of the chromatograph include a liquid chromatograph and a supercritical fluid chromatograph. In an aspect of the present embodiment, the chromatograph is preferably a liquid chromatograph or a supercritical fluid chromatograph.

In the present embodiment, the conditions for chromatograph analysis are not particularly limited, and may be designed as appropriate. For example, the analysis conditions described below in the Examples section may be adopted.

<Estimating a Combination of the Total Number of Carbon Atoms and the Total Number of Carbon-Carbon Double Bond(s) in the Acyl Group in the Target Compound from the Retention Time>

In this step, a combination of the total number of carbon atoms and the total number of carbon-carbon double bond(s) in the acyl group in the target compound is estimated from the retention time, based on the following equations 1 and 2.

N=f(T) (Equation 1)

T=t/D^{m} (Equation 2)

(Equation 1: Function that expresses the correlation between the total number N of carbon atoms in the acyl group and the retention time T for a saturated compound corresponding to the target compound)

In the equation 1, N represents the total number of carbon atoms in the acyl group, and f(T) represents a function that is derived from a homologue of a saturated compound corresponding to the target compound and that expresses the correlation between the total number N of carbon atoms and the retention time T for the saturated compound.

In the present embodiment, “N=f(T)” means that once the retention time T for the saturated compound corresponding to the target compound is determined, the total number N of carbon atoms in its acyl group is determined as a single value. Also, this can be understood in another way: the total number N of carbon atoms in the corresponding acyl group is a function of the retention time T for the saturated compound corresponding to the target compound. Herein, f(T) may be expressed as a mathematical expression, or may not be expressed as a mathematical expression. In an aspect of the present embodiment, when f(T) is expressed as a mathematical expression, this mathematical expression may be an expression approximated to a straight line (a linear function), or may be an expression approximated to a spline curve (such as a quadratic function).

In the present embodiment, f(T) is a function that is derived from a homologue of a saturated compound corresponding to the target compound. Herein, “a saturated compound corresponding to the target compound” means a compound that can be derived from the target compound by changing all the carbon-carbon double bonds in the acyl group to single bonds. When the acyl group in the target compound has no carbon-carbon double bond, the target compound is the same as the saturated compound corresponding to the target compound. In the present embodiment, “a homologue of a saturated compound” means a member of a group of compounds which can be derived from the saturated compound and in which the number of carbon atoms in the acyl group is different from each other.

In an aspect of the present embodiment, the target compound, the saturated compound corresponding to the target compound, and the homologue of the saturated compound share the same main chemical structure. Herein, the “main chemical structure” means a portion of the chemical structure of the target compound except the acyl group. For example, when the target compound is a triacylglycerol, its main chemical structure is a chemical structure attributable to glycerol. The main chemical structure of the target compound is known in advance because the target chemical structure is specified at the start of the analysis. For example, in the case where a triacylglycerol is to be analyzed as the target compound, at the time when the triacylglycerol is selected as the target, the main chemical structure may be known to be a chemical structure that is attributable to glycerol.

In the present embodiment, “the total number of carbon atoms in the acyl group(s)” means the sum of the carbon atoms in all the acyl groups bonded in the target compound.

In the present embodiment, T in f(T) means the retention time for the saturated compound corresponding to the target compound. The retention time T for the saturated compound is calculated by the equation 2, which is explained below.

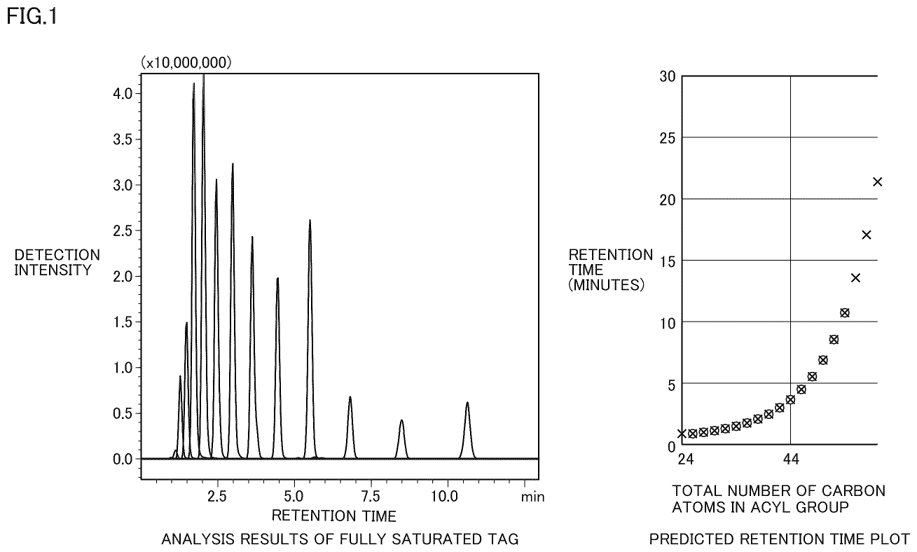

f(T) can be derived by the procedure described below, for example. Firstly, two or more homologues of the saturated compound are prepared. Each of these homologues thus prepared is a compound in which the total number N of carbon atoms in the acyl group is known. The homologue thus prepared is subjected to analysis on a chromatograph to determine the retention time T for the homologue. The correlation between the total number N of carbon atoms in the acyl group and the corresponding retention time T are plotted, and thereby f(T) is derived (for example, the right graph in FIG. 1). Based on the plot thus obtained, an approximate expression may be determined and regarded as an expression that represents f(T). That is, in an aspect of the present embodiment, f(T) in the equation 1 is preferably a function that is derived from two or more homologues.

(Equation 2: Mathematical relation between the retention time t for the target compound and the retention time T for the saturated compound corresponding to the target compound)

In the equation 2, t represents the retention time for the target compound, D represents a coefficient based on carbon-carbon double bond(s), and m represents the total number of carbon-carbon double bond(s).

It is conventionally known that, as for a given triacylglycerol having a fixed total number of carbon atoms in the acyl groups, the retention time tends to decrease along with an increase in the total number of carbon-carbon double bond(s) in the acyl groups, but this phenomenon has not been specifically explained yet. After intensive research, the inventors of the present invention have discovered that, as for a given triacylglycerol having a fixed total number of carbon atoms in the acyl groups, the retention time T for the saturated compound is proportional to the retention time t for the target compound, with the proportionality constant being (1/D^{m}). This discovery has made it possible to perform easy and simple estimation for a target compound containing an acyl group, in terms of a combination of the total number N of carbon atoms in the acyl group and the total number m of carbon-carbon double bond(s) in the acyl group from the retention time t based on the equations 1 and 2.

The coefficient D based on carbon-carbon double bond(s) is more than 0 and less than 1. In an aspect of the present embodiment, when the decrement of retention time caused by an increase of one carbon-carbon double bond is constant regardless of the total number of carbon-carbon double bond(s), it is proper to employ the method of estimating a structure according to the present embodiment. The coefficient D based on carbon-carbon double bond(s) can be determined in the manner described below, for example. Firstly, two or more compounds are prepared that share the same main chemical structure, share the same total number of carbon atoms in the acyl group, and are different in the total number of carbon-carbon double bond(s) in the acyl group. Each of these compounds thus prepared is subjected to analysis on a chromatograph to determine the retention time for the compound. From the total number of carbon-carbon double bond(s) in the acyl group and the corresponding retention time, the decrement of retention time caused by an increase of one carbon-carbon double bond is determined. When the difference in the decrements thus determined is small, the average value of the decrements thus determined is regarded as D. When the difference in the decrements thus determined is large and when it is desired to enhance the accuracy of analysis for a target compound with a relatively low degree of unsaturation, the decrement of retention time caused by an increase of the total number of carbon-carbon double bond(s) from 0 to 1 is regarded as D.

In the present embodiment, the total number m of carbon-carbon double bond(s) in the equation 2 is not particularly limited, and may be not less than 0 and not more than 6. Within this range, it is proper to employ the method of estimating a structure according to the present embodiment.

With the use of the equation 1 and the equation 2 described above, from the retention time t for the target compound as well as an assumed total number m of carbon-carbon double bond(s), it is possible to determine the total number N of carbon atoms in the acyl group in the target compound. In other words, from the retention time t for the target compound, it is possible to estimate a combination of the total number N of carbon atoms and the total number m of carbon-carbon double bond(s) in the acyl group in the target compound. In the present embodiment, “estimating” also encompasses narrowing down the possible candidates for the above-described combination. To take a triacylglycerol as an example, three acyl groups are bonded in it and, for each one of these acyl groups, approximately 28 chemical structures are known (see Table 1). In this case, there would be 3276 combinations for these acyl groups. By employing the method of estimating a structure according to the present embodiment, from the assumed total number m of carbon-carbon double bond(s), it is possible to determine the total number N of carbon atoms in the acyl groups as a single value, and thereby it is possible to greatly narrow down the candidates for the analysis target triacylglycerol.

TABLE 1

| Total number of | Total number of | |
|---|---|---|
| carbon atoms | double bonds | Abbreviation |
| 6 | 0 | 6:0 |
| 8 | 0 | 8:0 |
| 10 | 0 | 10:0 |
| 12 | 0 | 12:0 |
| 14 | 0 | 14:0 |
| 14 | 1 | 14:1 |
| 16 | 0 | 16:0 |
| 16 | 1 | 16:1 |
| 18 | 0 | 18:0 |
| 18 | 1 | 18:1 |
| 18 | 2 | 18:2 |
| 18 | 3 | 18:3 |
| 18 | 4 | 18:4 |
| 20 | 0 | 20:0 |
| 20 | 1 | 20:1 |
| 20 | 2 | 20:2 |
| 20 | 3 | 20:3 |
| 20 | 4 | 20:4 |
| 20 | 5 | 20:5 |
| 22 | 0 | 22:0 |
| 22 | 1 | 22:1 |
| 22 | 2 | 22:2 |
| 22 | 3 | 22:3 |
| 22 | 4 | 22:4 |
| 22 | 5 | 22:5 |
| 22 | 6 | 22:6 |
| 24 | 0 | 24:0 |
| 24 | 1 | 24:1 |

### <Other Steps>

Preferably, an aspect of the present embodiment further comprises analyzing the target compound on a mass spectrometer.

The method for ionization on a mass spectrometer is not particularly limited, and matrix-assisted laser desorption ionization (MALDI), electrospray ionization (ESI), nanoelectrospray ionization (nano-LSI), and the like may be employed. In the present embodiment, the ionization method is preferably ESI. In ionization in mass spectrometry, either a positive ion mode or a negative ion mode may be used. Mass spectrometry may be carried out in multiple steps.

Examples of the mass spectrometer include a Fourier transform mass spectrometer, a time-of-flight (Q-TOF) mass spectrometer, a triple quadrupole mass spectrometer, a single quadrupole mass spectrometer, and the like. In the present embodiment, from the viewpoint of the accuracy in analyzing a known component in a short time, the mass spectrometer is preferably a triple quadrupole mass spectrometer.

In an aspect of the present embodiment, analyzing a sample containing a target compound on a chromatograph and analyzing the target compound on a mass spectrometer may be carried out successively. For example, these two steps may be carried out successively with the use of a liquid chromatograph-tandem mass spectrometer. Typically, the liquid chromatograph-tandem mass spectrometer is a liquid chromatograph-triple quadrupole mass spectrometer or a liquid chromatograph-quadrupole/time-of-flight (Q-TOF) mass spectrometer. Usually, when such a liquid chromatograph-tandem mass spectrometer is used, an analysis parameter is determined for each component contained in the eluate after separation on the liquid chromatograph, for the highest possible detection sensitivity, namely for the best possible performance.

Up to this point, the method of estimating a structure according to the first aspect of the present invention has been described. This method of estimating a structure may be implemented directly by the person in charge of measurement, or a computer may be caused to implement this method.

### <<Computer-Readable Storage Medium>>

A second aspect of the present invention relates to a computer-readable storage medium storing a database that is to be used for causing a computer to implement the method of estimating a structure according to the first aspect, wherein
the database stores:
   analysis conditions for the chromatograph; and
   the function f(T) derived at the time of analysis of the homologue under the analysis conditions, and the coefficient D based on carbon-carbon double bond(s),
   in association with one another.

Examples of the analysis conditions for the chromatograph include the type of the mobile phase, the flow speed of the mobile phase, the gradient conditions for the mobile phase, the type of the stationary phase, the measurement temperature, the pressure, and the like.

As for the other information also stored in the database, examples thereof include mass information on the analysis target, information on the retention time, the intensity of the detector signal, and the like.

The storage medium is not particularly limited provided that it is a generally used storage medium, and examples include optical disks (such as CD-ROM, DVD-ROM, BD-ROM), magneto-optical disks, flash memories, and the like.

### EXAMPLES

In the following, a more detailed description will be given of the present invention with reference to examples; however, it should be noted that the below description does not limit the present invention.

### Experiment 1: Correlation Between the Total Number N of Carbon Atoms in the Acyl Group and the Retention Time T

For the purpose of investigating the correlation between the total number N of carbon atoms in the acyl group and the retention time T, the following experiment was carried out. Firstly, reference standards of triacylglycerol (which can be expressed as “TAG” hereinafter) described below were prepared. Each of the reference standards was a compound in which the total number of carbon-carbon double bond(s) in the acyl groups was 0 (a saturated compound).

### (Triacylglycerol Reference Standards)

Saturated triacylglycerol mix reference standards (with a total number of carbon atoms from 26 to 54)

Each of the reference standards was analyzed on a supercritical fluid chromatograph (manufactured by Shimadzu Corporation; trade name Nexera UC) to determine the retention time. The analysis conditions were as follows:

### (Analysis Conditions for Supercritical Fluid Chromatograph)

Column: Shim-pack XR-ODSIII, 150×2.0 mm I.D., 2.2 μm
Flow Rate: 0.8 mL/min
Modifier (Pump B): Acetonitrile
Time program B conc. 10%
Back Pressure Regulator: 10 MPa
Oven Temperature: 25° C.
Injection Volume: 0.5 μL

### (LCMS-8050 and Interface Conditions)

Make-up solvent: 0.2 mL/min (Methanol with 10 mM ammonium acetate)
Interface: DUIS
MS Mode: Positive mode
Block Temperature: 40° C.
DL Temperature: 235° C.
Nebulizing Gas Flow: 2 L/min
Drying Gas Flow: 10 L/min
Heating Gas Flow: 10 L/min

FIG. 1 shows a graph that presents results of analysis of fully saturated triacylglycerols carried out on a supercritical fluid chromatograph (left), and a graph that presents the correlation between the total number of carbon atoms in the acyl groups in the triacylglycerols (on the horizontal axis) and the retention time (on the vertical axis) based on the analysis results (right). On the right graph in FIG. 1, the circles indicate measurement results of the triacylglycerol reference standards, and the crosses indicate predicted retention obtained from the function N=f(T). From the right graph in FIG. 1, it was demonstrated that the total number N of carbon atoms in the acyl groups in the triacylglycerols was a function of the retention time T. This graph was approximated by a least square method to derive the following equation 1′:

$$N = f ( T ) = 0.0000271053186070559 \times ( {T}^{4} ) - 0.00363140807472355 \times ( {T}^{3} ) + 0.186952207220782 \times ( {T}^{2} ) - 4.24830631212859 \times ( T ) + 36.3581033113478 \qquad ( Equation 1 ’ )$$

### Experiment 2: Correlation Between the Total Number m of Carbon-Carbon Double Bond(s) in the Acyl Groups and the Retention Time t

For the purpose of investigating the correlation between the total number m of carbon-carbon double bond(s) in the acyl groups and the retention time t, the following experiment was carried out. Firstly, triacylglycerol reference standards described below were prepared. Each of the reference standards was a compound in which the total number of carbon atoms in the acyl groups was 48.

### (Triacylglycerol Reference Standards)

Mix samples of triacylglycerol ((48:0), (48:1), (48:2), and (48:3))

Each of the reference standards was analyzed on a supercritical fluid chromatograph (manufactured by Shimadzu Corporation; trade name Nexera UC) to determine the retention time. The analysis conditions were the same as in Experiment 1.

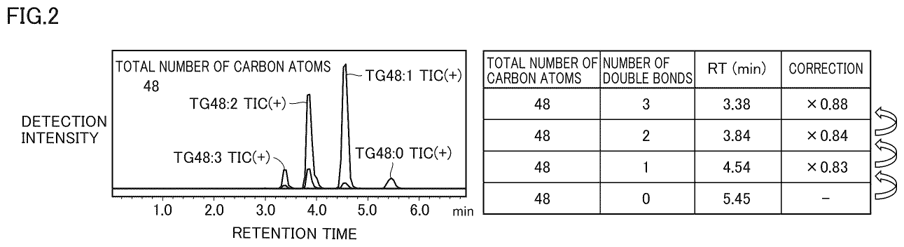

FIG. 2 shows a graph that presents results of analysis of the triacylglycerols carried out on a supercritical fluid chromatograph (left), and a table that presents the correlation between the total number of carbon-carbon double bond(s) in the acyl groups in the triacylglycerols and the retention time based on the analysis results (right). From the table in FIG. 2, it was demonstrated that as the total number m of carbon-carbon double bond(s) in the acyl groups in the triacylglycerols increases by one, the retention time t decreases by a factor of 0.83 to 0.88. From this table, an equation 2′ was derived, which is described below. In the equation 2′, T means the retention time for a saturated compound corresponding to the above-mentioned reference standard (target compound). t and m mean the retention time for the above-mentioned reference standard (target compound) and the total number of carbon-carbon double bond(s) in the acyl groups, respectively. D means the decrement of retention time caused by an increase of one carbon-carbon double bond (a coefficient based on carbon-carbon double bond(s)). In other words, it was demonstrated that the retention time T for a saturated compound corresponding the reference standard is proportional to the retention time t for the reference standard, with the proportionality constant being (1/D^{m}, D=0.83 to 0.88).

T=t/D^{m} (Equation 2′)

### Experiment 3: Estimation of Retention Time

Based on the results from Experiment 1 and Experiment 2, the retention time for a triacylglycerol in which N is 52 and m is 2 (TAG (52:2)) was estimated. The phenomenon of a change in the retention time caused by an increase in the total number of carbon-carbon double bond(s) is independent of the phenomenon of a change in the retention time caused by a change in the total number of carbon atoms in the acyl groups, and, therefore, it is conceivable that for the case of N=48 (Experiment 2) and for the case of N=52 (Experiment 3), D values that are similar to some extent can be used. The retention time for a saturated compound (TAG (52:0)) corresponding to TAG (52:2) was determined in advance, and it was 8.55 minutes. From Experiment 2, the decrement of retention time caused by an increase of the total number of carbon-carbon double bond(s) from 0 to 1 was 0.83, and, therefore, the retention time for TAG (52:2) was estimated at 5.89 (minutes).

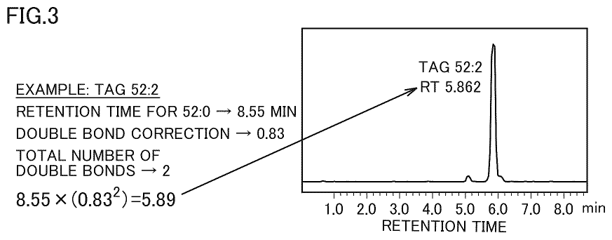

Meanwhile, TAG (52:2) was analyzed on a supercritical fluid chromatograph under the same conditions as in Experiment 1, and it was found that the retention time was 5.862 minutes, which was almost the same as the above-described estimate of the retention time (FIG. 3).

Thus, from the results of Experiment 1 to Experiment 3, it was demonstrated that with the use of the equation 1 and the equation 2 described above, from the retention time t for the target compound, it is possible to perform easy and simple estimation for a target compound containing an acyl group, in terms of a combination of the total number of carbon atoms in the acyl group as well as the total number of carbon-carbon double bond(s) in the acyl group.

### [Aspects]

As will be appreciated by those skilled in the art, the above-described example embodiments are specific examples of the below aspects.
(Item 1) A method of estimating a structure according to an aspect is:
a method of estimating a structure of a target compound containing a linear acyl group, the method comprising: analyzing a sample containing the target compound on a chromatograph to determine a retention time; and estimating a combination of a total number of carbon atoms and a total number of carbon-carbon double bond(s) in the acyl group in the target compound from the retention time, based on the following equations 1 and 2:

N=f(T) (Equation 1)

T=t/D^{m} (Equation 2)

in the equation 1, N represents the total number of carbon atoms in the acyl group, and f(T) represents a function that is derived from a homologue of a saturated compound corresponding to the target compound and that expresses a correlation between the total number of carbon atoms and the retention time; and in the equation 2, t represents the retention time, D represents a coefficient based on carbon-carbon double bond(s), and m represents the total number of carbon-carbon double bond(s). With the method of estimating a structure according to Item 1, it is possible to provide a method for easy and simple estimation for a target compound containing an acyl group, in terms of the total number of carbon atoms in the acyl group as well as the total number of carbon-carbon double bond(s) in the acyl group.
(Item 2) In the method of estimating a structure according to Item 1, the target compound is a triacylglycerol. With the method of estimating a structure according to Item 2, it is possible to perform easy and simple estimation of the chemical structure of a triacylglycerol.
(Item 3) In the method of estimating a structure according to Item 1 or Item 2, f(T) in the equation 1 is a function that is derived from two or more types of the homologue. With the method of estimating a structure according to Item 3, it is possible to perform easy, simple, and accurate estimation for a target compound containing an acyl group, in terms of the total number of carbon atoms in the acyl group as well as the total number of carbon-carbon double bond(s) in the acyl group.
(Item 4) In the method of estimating a structure according to any one of Item 1 to Item 3, the chromatograph is a liquid chromatograph or a supercritical fluid chromatograph. With the method of estimating a structure according to Item 4, it is possible to perform easy, simple, and accurate estimation for a target compound containing an acyl group, in terms of the total number of carbon atoms in the acyl group as well as the total number of carbon-carbon double bond(s) in the acyl group.
(Item 5) The method of estimating a structure according to any one of Item 1 to Item 4 further comprises analyzing the target compound on a mass spectrometer. With the method of estimating a structure according to Item 5, not only it is possible to perform easy and simple estimation for a target compound containing an acyl group, in terms of the total number of carbon atoms in the acyl group as well as the total number of carbon-carbon double bond(s) in the acyl group, it is also possible to obtain more detailed structure information.
(Item 6) In the method of estimating a structure according to Item 5, the mass spectrometer is a triple quadrupole mass spectrometer. With the method of estimating a structure according to Item 6, not only it is possible to perform easy and simple estimation for a target compound containing an acyl group, in terms of the total number of carbon atoms in the acyl group as well as the total number of carbon-carbon double bond(s) in the acyl group, it is also possible to obtain more detailed structure information.
(Item 7) A storage medium according to an aspect is:
a computer-readable storage medium storing a database that is to be used for causing a computer to implement the method of estimating a structure according to any one of Item 1 to Item 6, wherein
the database stores:
   analysis conditions for the chromatograph; and
   the function f(T) derived at the time of analysis of the homologue under the analysis conditions, and the coefficient D based on carbon-carbon double bond(s), in association with one another.

With the storage medium according to Item 7, it is possible to cause a computer to implement the method of estimating a structure according to any one of Item 1 to Item 6.

The embodiment and example of the present invention are described above, and the configurations of the above embodiment and example may be combined as appropriate.

The embodiment and example disclosed herein are illustrative and non-restrictive in any respect. The scope of the present invention is defined by the terms of the claims, not by the embodiment and example, and intended to encompass all modifications and variations equivalent in meaning and scope to the claims.

What is claimed is:

1. A method of estimating a structure of a target compound containing a linear acyl group, the method comprising:
analyzing a sample containing the target compound on a chromatograph to determine a retention time; and
estimating a combination of a total number of carbon atoms and a total number of carbon-carbon double bond(s) in the acyl group in the target compound from the retention time, based on the following equations 1 and 2:
N=f(T) (Equation 1)
T=t/D^{m} (Equation 2)
in the equation 1, N represents the total number of carbon atoms in the acyl group, and f(T) represents a function that is derived from a homologue of a saturated compound corresponding to the target compound and that expresses a correlation between the total number of carbon atoms and the retention time; and in the equation 2, t represents the retention time, D represents a coefficient based on carbon-carbon double bond(s), and m represents the total number of carbon-carbon double bond(s).

2. The method of estimating a structure according to claim 1, wherein the target compound is a triacylglycerol.

3. The method of estimating a structure according to claim 1, wherein f(T) in the equation 1 is a function that is derived from two or more types of the homologue.

4. The method of estimating a structure according to claim 1, wherein the chromatograph is a liquid chromatograph or a supercritical fluid chromatograph.

5. The method of estimating a structure according to claim 1, further comprising:
analyzing the target compound on a mass spectrometer.

6. The method of estimating a structure according to claim 5, wherein the mass spectrometer is a triple quadrupole mass spectrometer.

7. A computer-readable storage medium, the computer-readable storage medium storing a database that is to be used for causing a computer to implement the method of estimating a structure according to claim 1, wherein
the database stores:
analysis conditions for the chromatograph; and
the function f(T) derived at the time of analysis of the homologue under the analysis conditions, and the coefficient D based on carbon-carbon double bond(s),
in association with one another.
